(19) United States
(12) Patent Application Publication
(10) Pub. No.: US 2004/0135832 A1
(43) Pub. Date: Jul. 15, 2004

(54) Droplet discharging apparatus and method

(76) Inventor: Hidenori Usuda, Matsumoto-shi (JP)

Correspondence Address: HARNESS, DICKEY & PIERCE, P.L.C., P.O. BOX 828, BLOOMFIELD HILLS, MI, 48303, US

(21) Appl. No.: 10/698,039

(22) Filed: Oct. 30, 2003

(30) Foreign Application Priority Data
Nov. 1, 2002 (JP) 2002-319678

(51) Int. Cl. B41J 29/38

(52) U.S. Cl. 347/10

(57) ABSTRACT

An apparatus discharges a discharge liquid in the form of droplets from apertures by mechanically deforming piezoelectric elements by a normal drive signal. A heating drive signal of a repetitive frequency in an ultrasonic band is applied to the piezoelectric to heat the droplets.

### BACKGROUND OF THE INVENTION

1. Technical Field of the Invention

The present invention relates to a droplet discharging apparatus and method for discharging droplets toward a target object by using a piezoelectric element.

2. Description of the Related Art

Japanese Unexamined Patent Application Publication No. 11-138798 discloses an inkjet printer as an example to which a droplet discharging apparatus has been applied. The inkjet printer is adapted to apply a heating signal exclusively used for heating a piezoelectric means (piezoelectric element) thereby to heat ink to an appropriate temperature by the heat generated by the piezoelectric means. The inkjet printer having the aforementioned construction allows ink to be heated without complicating the structure of its head and also makes it possible to avoid adverse influences on image pictures attributable to changes in ink viscosity caused by changes in temperature.

In the inkjet printer described above, the heating signal repetitive frequency is set above the resonance frequency of the head so as to prevent ink from being discharged from the head, or the amplitude of the heating signal is set such that the ink will not be discharged when the repetitive frequency is set in the vicinity of the resonance frequency. According to the prior art described above, the head drive signal generating means and the heating signal generating means are separately provided, resulting in a complicated circuit configuration. Furthermore, the heating signal is merely applied to the piezoelectric element (piezo-element) outside an image forming region, so that the temperature of the ink may have been dropped, under some head driving conditions, by the time the ink is discharged in the image forming region. The mechanism, therefore, is not appropriate for rapidly heating the ink so as to restrain the adverse influences (poor discharge) caused by a drop in the ink temperature. Hence, there has been a demand for developing a better means

### SUMMARY OF THE INVENTION

The present invention has been made in view of the problems described above, and the objects of the invention are to:

(1) rapidly heat a discharge liquid by the heat generated by a piezoelectric element, and

(2) rapidly heat the discharge liquid immediately preceding the discharge so as to restrain the deterioration in discharging performance attributable to temperature changes in the discharge liquid.

To fulfill the aforesaid objects, a first means related to, a droplet discharging apparatus for discharging a discharge liquid in the form of droplets through an aperture by mechanically deforming a piezoelectric element by a normal drive signal adopts a construction in which the piezoelectric element is subjected to a heating drive signal of a repetitive frequency in an ultrasonic band, which is different from the normal drive signal and prevents any droplets from being discharged through the aperture.

Furthermore, a second means related to a droplet discharging apparatus adopts a construction in which the heating drive signal is applied to the piezoelectric element immediately before a droplet is discharged by the normal drive signal in the above first means.

A third means related to a droplet discharging apparatus adopts a construction in which the heating drive signal is applied to the piezoelectric element while a droplet is being discharged by the normal drive signal in the above first or second means.

A fourth means related to a droplet discharging apparatus adopts a construction in which the heating drive signal is applied to the piezoelectric element if the temperature of a discharge liquid that is detected by a temperature detecting means drops below a predetermined threshold temperature in any one of the above first to third means.

A fifth means related to a droplet discharging apparatus adopts a construction in which the repetitive frequency of the heating drive signal is 40 kHz or more in any one of the above first to fourth means.

A sixth means related to a droplet discharging apparatus adopts a construction in which the amplitude of the heating drive signal is half that or less of the normal drive signal in any one of the first to fifth means.

A seventh means related to a droplet discharging apparatus adopts a construction in which the discharge liquid is a printing ink in any one of the above first to sixth means.

An eighth means related to a droplet discharging apparatus adopts a construction in which the discharge liquid is an electrically conductive material for forming a wiring pattern in any one of the above first to sixth means.

A ninth means related to a droplet discharging apparatus adopts a construction in which the discharge liquid is a transparent resin for forming a microlens in any one of the above first to sixth means.

A tenth means related to a droplet discharging apparatus adopts a construction in which the discharge liquid is a resin for forming a color layer of a color filter in any one of the above first to sixth means.

An eleventh means related to a droplet discharging apparatus adopts a construction in which the discharge liquid is an electro-optic material in any one of the first to sixth means.

A twelfth means related to a droplet discharging apparatus adopts a construction in which the electro-optic material is a fluorescent organic compound presenting electroluminescence in the above eleventh means.

A thirteenth means related to a droplet discharging apparatus adopts a construction in which the heating drive signal is applied to the piezoelectric element before, during and after preliminary discharging (flushing) in any one of the first to twelfth means.

As a first means related to a droplet discharging method for discharging a discharge liquid through an aperture by mechanically deforming a piezoelectric element by normal drive, a construction is adopted in which the discharge liquid is heated by subjecting the piezoelectric element to heating drive at a repetitive frequency in an ultrasonic band, the heating drive preventing the discharge liquid from being discharged through the aperture.

As a second means related to a droplet discharging method, a construction is adopted in which the heating drive is carried out immediately before the normal drive for discharging a droplet in the above first means.

As a third means related to a droplet discharging method, a construction is adopted in which the heating drive is carried out during the normal drive in the above first or second means.

As a fourth means related to a droplet discharging method, a construction is adopted in which the heating drive is carried out if the temperature of a discharge liquid drops below a predetermined threshold temperature in any one of the above first to third means.

As a fifth means related to a droplet discharging method, a construction is adopted in which the repetitive frequency of the heating drive is 40 kHz or more in any one of the above first to fourth means.

As a sixth means related to a droplet discharging method, a construction is adopted in which the heating drive is carried out at an amplitude that is half that or less of the normal drive in any one of the above first to fifth means.

As a seventh means related to a droplet discharging method, a construction is adopted in which the discharge liquid is a printing ink in any one of the above first to sixth means.

As an eighth means related to a droplet discharging method, a construction is adopted in which the discharge liquid is an electrically conductive material for forming a wiring pattern in any one of the above first to sixth means.

As a ninth means related to a droplet discharging method, a construction is adopted in which the discharge liquid is a transparent resin for forming a microlens in any one of the above first to sixth means.

As a tenth means related to a droplet discharging method, a construction is adopted in which the discharge liquid is a resin for forming a color layer of a color filter in any one of the first to sixth means.

As an eleventh means related to a droplet discharging method, a construction is adopted in which the discharge liquid is an electro-optic material in any one of the first to sixth means.

As a twelfth means related to a droplet discharging method, a construction is adopted in which the electro-optic material is a fluorescent organic compound presenting electroluminescence in the eleventh means.

As a thirteenth means related to a droplet discharging method, a construction is adopted in which the heating drive signal is applied to the piezoelectric element before, during and after preliminary discharging (flushing) in any one of the first to twelfth means.

### BRIEF DESCRIPTION OF THE DRAWINGS

FIG. 1 is a perspective view showing the entire construction of a droplet discharging apparatus according to an embodiment of the present invention.

FIG. 2 is an exploded perspective view showing the detailed construction of a discharging head 7 in the embodiment of the present invention.

FIG. 3 is a longitudinal sectional view showing the detailed construction of an actuator 23 in the embodiment of the present invention.

FIG. 4 is a block diagram showing the electric functional construction of the droplet discharging apparatus according to the embodiment of the present invention.

FIG. 5 is a schematic diagram showing the waveforms (for 1 cycle) of a normal drive signal and a heating drive signal in the embodiment of the present invention.

FIG. 6 is a schematic diagram showing the arrangement relationship between the normal drive signal and the heating drive signal and the positional relationship between a flushing drive signal and the heating drive signal in the embodiment of the present invention.

### DESCRIPTION OF THE PREFERRED EMBODIMENTS

An embodiment of the droplet discharging apparatus and method in accordance with the present invention will be explained in conjunction with the accompanying drawings.

Construction of the droplet discharging apparatus

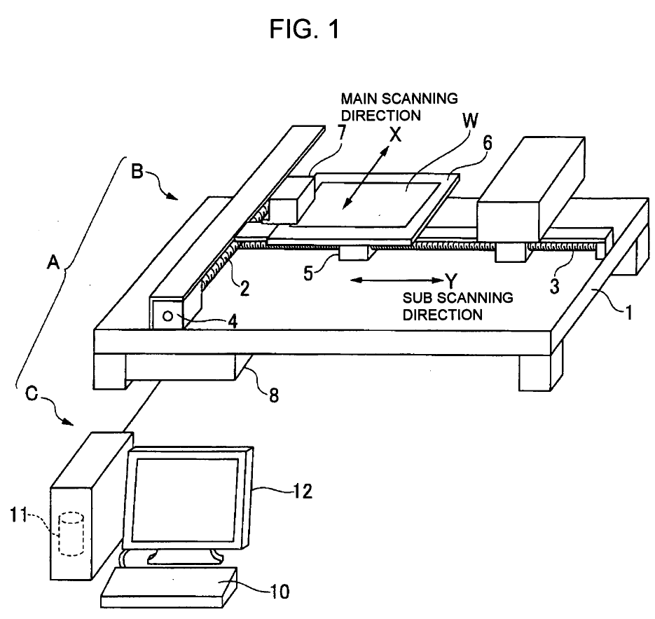

FIG. 1 is a perspective view showing the entire construction of a droplet discharging apparatus according to one embodiment. As shown in FIG. 1, a droplet discharging apparatus A is constructed of a main unit B and a control computer C. The main unit B is constructed primarily of a base 1, an X-direction drive shaft 2, a Y-direction drive shaft 3, an X-direction drive motor 4, a Y-direction drive motor 5, a stage 6, a discharging head 7, and a controller 8. The control computer C is provided primarily with a keyboard 10, an external memory 11, and a display 12.

The base 1 is a rectangular flat plate having a predetermined area, its front surface (upper surface) being provided with the X-direction drive shaft 2 and the Y-direction drive shaft 3 disposed to be orthogonal to each other. The X-direction drive shaft 2 is constructed of a ball screw or the like and rotatively driven by the X-direction drive motor 4. The X-direction drive motor 4 is, for example, a stepping motor, and revolves the X-direction drive shaft 2 on the basis of the drive signals received from the controller 8 so as to move the discharging head 7 in the X-direction (main scanning direction) on the base 1.

The Y-direction drive shaft 3 is composed of a ball screw, as in the case of the X-direction drive shaft 2, and is rotatively driven by the Y-direction drive motor 5. The Y-direction drive motor 5 is, for example, a stepping motor, and revolves the Y-direction drive shaft 3 on the basis of the drive signals received from the controller 8 so as to move the stage 6 in the Y-direction (sub scanning direction) on the base 1. The stage 6 is a rectangular flat plate on which an object W is fixedly rested on the upper surface thereof. The object W is the target to which the droplets discharged from the discharging head 7 are applied. The objects W may be various types of paper, substrates, etc.

The discharging head 7 is adapted to discharge a discharge liquid, which is held therein, in the form of droplets by utilizing the mechanical deformation of a piezoelectric element. The detailed construction of the discharging head 7 will be described hereinafter. A variety of types of discharge liquid is used according to the applications of the droplet discharging apparatus A. The discharge liquids may be, for example, diverse types of ink or resin, or electro-optical materials. The controller 8 controls and drives the X-direction drive motor 4, the Y-direction drive motor 5 and the discharging head 7 under the control of the control computer C.

The keyboard 10, which is an element of the control computer C, is used to enter the information regarding diverse types of setting, including discharging conditions for discharging droplets toward the object W. The external memory 11 is, for example, a hard disk device, and stores the information regarding diverse types of setting input through the keyboard 10. The display 12 is for displaying on its screen the information regarding various types of setting already stored in the external memory 11 or the information regarding various types of setting entered through the keyboard 10.

The droplet discharging apparatus A constructed as described above operates the X-direction drive motor 4 and the Y-direction drive motor 5 under the control of the control computer C so as to set the relative positional relationship between the object W and the discharging head 7 and to discharge droplets from the discharging head 7 toward a desired position on the object W so as to adhere the droplets thereto.

Detailed Construction of the Discharging Head 7

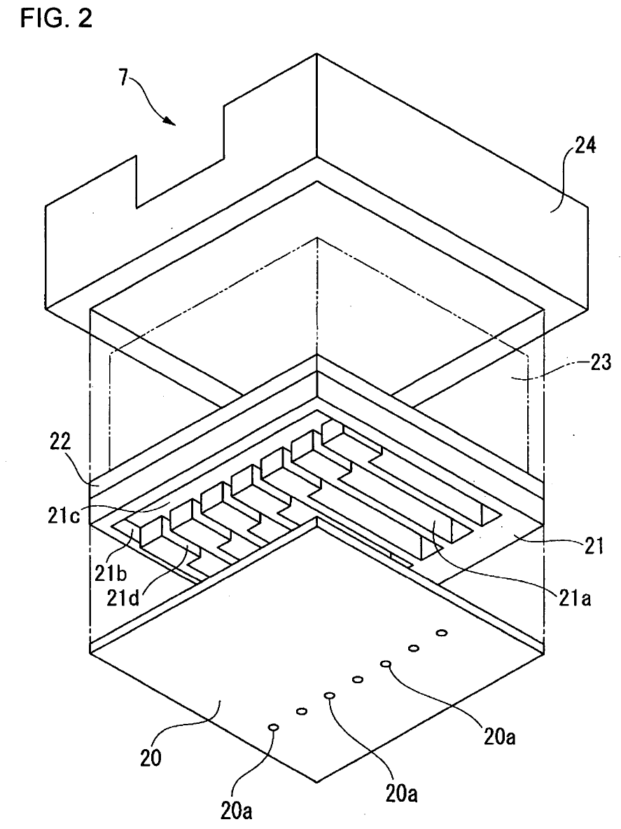

FIG. 2 is an exploded perspective view showing the detailed construction of the discharging head 7. The discharging head 7 is composed primarily of a nozzle plate 20, a pressure generating chamber plate 21, a diaphragm 22, an actuator 23 and a casing 24.

The nozzle plate 20 is a flat plate in which a plurality of discharging apertures 20a is formed at predetermined intervals. The pressure generating chamber plate 21 is formed of a flat plate with its bottom surface bonded to the upper surface of the nozzle plate 20, and has pressure generating chambers 21a, side walls (partition walls) 21b, a reservoir 21c and a lead-in passages 21d, which are formed by etching. The plural pressure generating chambers 21a are provided in association with the discharging apertures 20a, and serve as the spaces for storing a discharge liquid immediately before discharging. The side walls 21b partition the pressure generating chambers 21a. The reservoir 21c is a flow channel for supplying a discharge liquid to the pressure generating chambers 21a. The lead-in passages 21d lead the discharge liquid from the reservoir 21c to the individual pressure generating chambers 21a.

The diaphragm 22 is an elastic deformable sheet and bonded to the upper surface of the pressure generating chamber plate 21. More specifically, the nozzle plate 20, the pressure generating chamber plate 21 and the diaphragm 22 make up a three-layer structure, the layers being bonded with an adhesive agent. The upper surface of the diaphragm 22 is provided with an actuator 23. The portions of the diaphragm 22 that are associated with the individual pressure generating chambers 21a are deformed perpendicular to the surface by the piezoelectric element in the actuator 23. The nozzle plate 20, the pressure generating chamber plate 21, the diaphragm 22 and the actuator 23 are housed together in the casing 24 to form the integral discharging head 7.

Detailed Construction of the Actuator 23

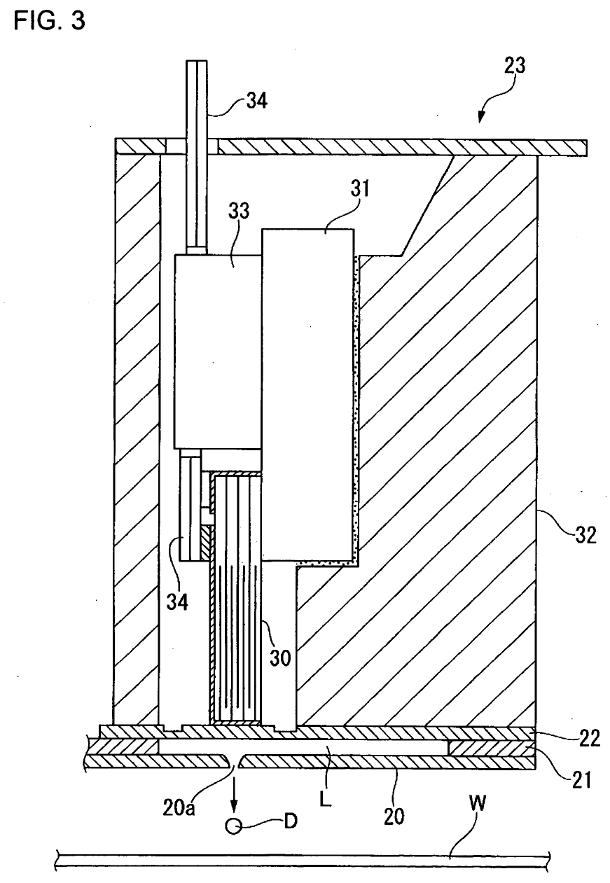

FIG. 3 is a longitudinal sectional view showing the detailed construction of the actuator 23. As shown in the figure, one end of a piezoelectric element 30 is adhesively secured to the portions of the diaphragm 22 that are associated with the individual pressure generating chambers 21a. The piezoelectric element 30 vertically expands and contracts when subjected to a voltage applied from outside. The other end of the piezoelectric element 30 is adhesively bonded to a fixed substrate 31. The fixed substrate 31 is adhesively secured to a holder 32. The holder 32 is secured on the diaphragm 22.

A drive integrated circuit 33 is adhesively secured on the fixed substrate 31. Various control signals and drive signals (normal drive signal and heating drive signal) are supplied from the controller 8 (refer to FIG. 1) to the drive integrated circuit 33 through a flexible cable 34. The drive integrated circuit 33 selectively outputs various drive signals on the basis of the aforesaid control signals. Various drive signals selected by the drive integrated circuit 33 are supplied to each piezoelectric element 30 through the flexible cable 34.

More specifically, in the discharging head 7 of the droplet discharging apparatus A, the piezoelectric elements 30 vertically expand and contract in response to various drive signals selectively supplied from the drive integrated circuit 33 to the piezoelectric elements 30. The expansion and contraction of the piezoelectric elements 30 cause the portion of the diaphragm 22 that is positioned right under the piezoelectric elements 30 to deform in the vertical direction, that is, in the direction perpendicular to the surface of the diaphragm 22. This causes a discharge liquid L held in the pressure generating chambers 21a to be discharged in the form of droplets D toward the object W.

Electric Functional Construction

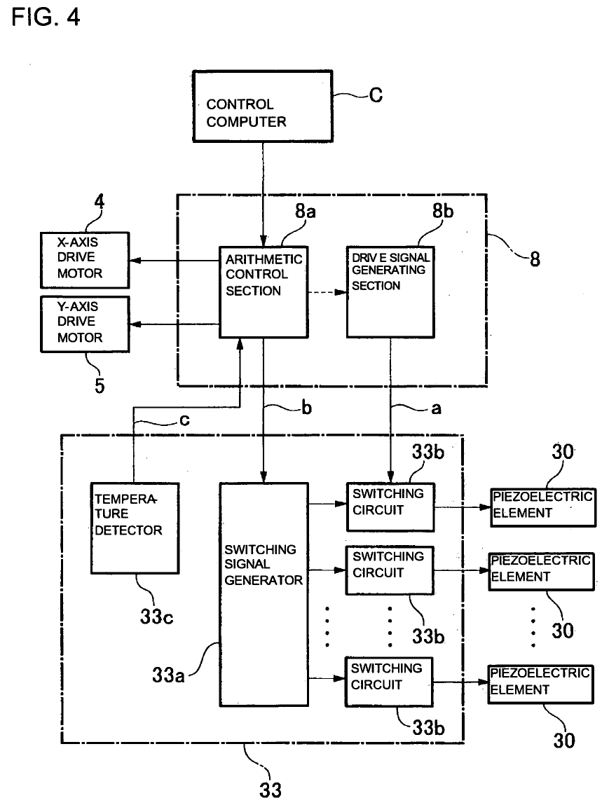

Referring now to FIG. 4, the electric functional construction of the droplet discharging apparatus A will be explained. As shown in FIG. 4, the controller 8 provided in the main unit B is constructed of an arithmetic control section 8a and a drive signal generating section 8b. The drive integrated circuit 33 provided in the discharging head 7 is composed mainly of a switching signal generator 33a, a switching circuit 33b and a temperature detector 33c.

The arithmetic control section 8a controls and drives the X-direction drive motor 4 and the Y-direction drive motor 5 according to the setting information received from the control computer C and control programs stored therein beforehand, and also outputs various types of data for generating various drive signals a for driving the piezoelectric elements 30 (data for generating drive signals) to the drive signal generating section 8b. Furthermore, the arithmetic control section 8a generates selection data b according to the control programs and outputs the generated selection data b to the switching signal generator 33a. The selection data b is formed of nozzle selection data for designating the piezoelectric element 30 to which the drive signal a is applied and waveform selection data for designating the drive signal to be applied to the piezoelectric element 30.

The arithmetic control section 8a is configured so as to generate the aforementioned waveform selection data, taking a temperature detection signal c received from the temperature detector 33c also into account. More specifically, the arithmetic control section 8a instructs the switching signal generator 33a to select either the normal drive signal or the heating drive signal on the basis of the temperature detection signal c.

The drive signal generating section 8b generates various drive signals of predetermined shapes, namely, the normal drive signal and the heating drive signal, based on the aforesaid data for generating drive signals, then outputs the generated signals to the switching circuit 33b.

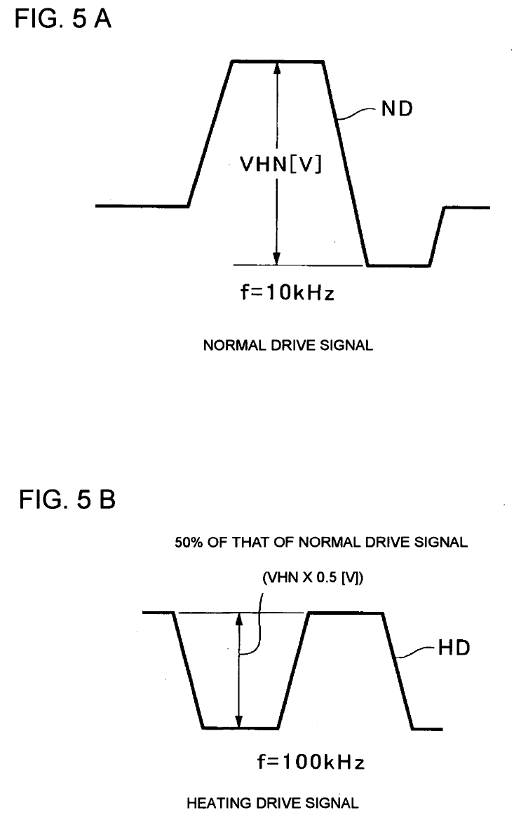

FIG. 5 is a schematic diagram showing the waveforms (1 cycle) of the normal drive signal and the heating drive signal. In FIG. 5, (a) shows the waveform of a normal drive signal ND, while (b) shows the waveform of a heating drive signal HD. When a repetitive frequency f of the normal drive signal ND is set at 10 kHz, the repetitive frequency f of the heating drive signal HD is preferably set at 40 kHz or more in the ultrasonic band. In this embodiment, the repetitive frequency f of the heating drive signal HD is set at 100 kHz. The repetitive frequency f in the vicinity of 100 kHz makes it possible to adequately drive (mechanically deform) the piezoelectric elements 30 and to generate operating heat with good responsiveness by driving the piezoelectric elements 30 at high speed. The amplitude of the heating drive signal HD is preferably set at a level that prevents droplets D from being discharged from the discharging apertures 20a, e.g., the half or less of an amplitude VHN of the normal drive signal ND. The amplitude of the heating drive signal HD in this embodiment is set to exactly half (50%) of the amplitude VHN of the normal drive signal ND.

The switching signal generator 33a generates switching signals indicating ON/OFF of the drive signal a to be supplied to the piezoelectric elements 30 on the basis of the selection data b and outputs the generated switching signals to the switching circuit 33b. The switching circuit 33b is provided for each piezoelectric element 30 and outputs the drive signal designated by a switching signal to the piezoelectric element 30. The temperature detector 33c detects the operating temperature of the drive integrated circuit 33 and outputs the detected temperature as the temperature detection signal c to the arithmetic control section 8a.

As shown in FIG. 3, the drive integrated circuit 33 is adhesively secured to the fixed substrate 31, and the other end of each of the piezoelectric elements 30, which generate heat (operating heat) by the actuation based on the drive signals, is adhesively secured to the fixed substrate 31. This means that the drive integrated circuit 33, which includes the temperature detector 33c, and the piezoelectric elements 30 are closely thermally coupled through the intermediary of the fixed substrate 31 featuring good thermal conductivity. Hence, the operating temperature of the drive integrated circuit 33 detected by the temperature detector 33c accurately reflects the operating heat of the piezoelectric elements 30. Furthermore, the piezoelectric elements 30 are in close thermal connection with the discharge liquid L through the intermediary of the diaphragm 22 (sheet), so that the temperature detector 33c substantially accurately detects the temperature of the discharge liquid L as the temperature of the piezoelectric elements 30 although there is some temperature difference.

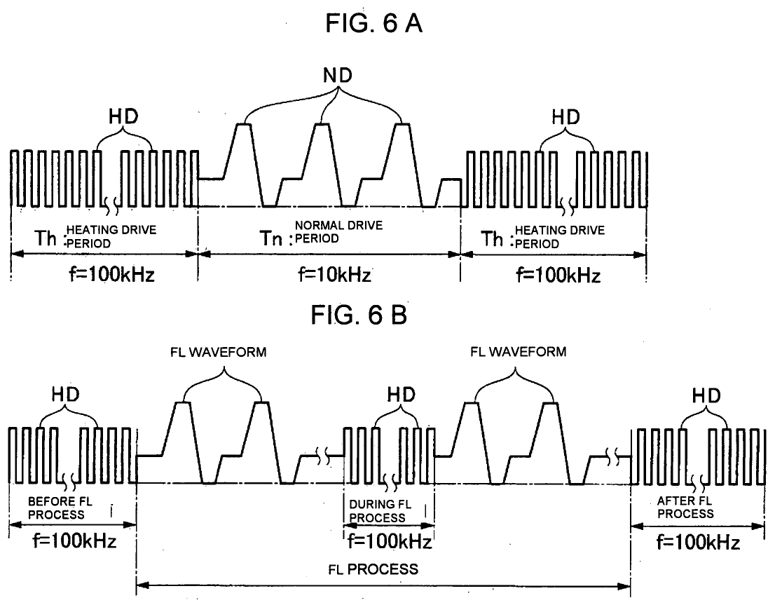

The operation of the droplet discharging apparatus constructed as described above will be explained in detail by referring also to FIG. 6.

First, the normal operation will be explained.

The control and drive of the X-direction drive motor 4 and the Y-direction drive motor 5 by the arithmetic control section 8a and the output of the selection data b supplied to the switching signal generator 33a, and the output of various drive signals issued by the drive signal generating section 8b to the switching circuit 33b are performed in synchronization. More specifically, in a state wherein the X-direction drive motor 4 and the Y-direction drive motor 5 have been actuated under the control and drive by the arithmetic control section 8a to set appropriate relative positions of the discharging head 7 and the object W, the normal drive signal ND is continuously applied to the piezoelectric elements 30 from the switching circuit 33b of the drive integrated circuit 33, causing the discharge liquid L to be continuously discharged as the droplets D from the discharging apertures 20a toward the object W.

The normal drive of the piezoelectric elements 30 is carried out at the repetitive frequency f of 10 kHz. In this case, the discharge liquid L is heated by the operating heat generated by the piezoelectric elements 30. A part of the discharge liquid L is discharged as the droplets D toward the object W, so that a part of the operating heat is released outside by the droplets D, leading to insufficient heating of the discharge liquid L. The rise in the temperature of the discharge liquid L is equivalently detected as the rise in the temperature of the piezoelectric elements 30 by the temperature detector 33c in the drive integrated circuit 33 in tight thermal connection with the piezoelectric elements 30 through the intermediary of the fixed substrate 31.

The arithmetic control section 8a monitors the temperature of the discharge liquid L on the basis of the temperature detection signal c received from the temperature detector 33c. If the temperature is below a predetermined threshold temperature, then the arithmetic control section 8a instructs the drive signal generating section 8b to generate the heating drive signal HD and also generates the selection data b calling for the application of the heating drive signal HD to the piezoelectric elements 30 and outputs the generated selection data b to the switching signal generator 33a. As a result, the heating drive signal HD is applied to the piezoelectric elements 30, and the piezoelectric elements 30 are driven in a non-discharge mode (heating drive) at the 100-kHz repetitive frequency f. The high-frequency drive at 100 kHz in the non-discharge mode causes the temperature of the discharge liquid L to rapidly rise. In other words, the heating drive signal HD is insufficient in frequency and/or amplitude to cause the piezoelectric elements 30 to discharge the droplets but the drive signal HD is sufficient in frequency and/or amplitude to energize the piezoelectric elements 30 to rapidly heat the droplets.

FIG. 6(a) is a schematic diagram showing the arrangement relationship between the normal drive signal ND and the heating drive signal HD. As shown in the figure, the heating drive signal HD is inserted between the normal drive signals ND so as to insert a heating drive period Th between normal drive periods Tn, thereby restraining a temperature drop of the discharge liquid L.

Generally, in the droplet discharging apparatus, between normal drive cycles, that is, in the stage immediately before the discharge for the following line is performed after the completion of the discharge for one line in the X-direction, the object W is subjected to a preliminary discharging process (flushing process) to secure proper discharging performance for the following line. The aforesaid heating drive period Th may be set in the flushing process, and applied between flushing drive signals or applied immediately preceding a flushing waveform to carry out flushing more effectively, or applied during the period between immediately after flushing and immediately before discharging thereby to properly accomplish discharging. In other words, as shown in FIG. 6(b), the piezoelectric elements 30 are subjected to heating drive before, during and after the flushing process carried out immediately preceding normal discharge, thus restraining the temperature drop of the discharge liquid L.

According to the embodiment, when the temperature of the discharge liquid L drops below a threshold temperature during normal drive, the piezoelectric elements 30 are switched from the normal drive to the drive at the repetitive frequency in the ultrasonic band in the non-discharge mode. This causes the temperature of the discharge liquid L to rapidly rise to maintain the temperature at a predetermined temperature or higher. It is therefore possible to effectively prevent discharge failure attributable to a temperature drop in the discharge liquid L. Moreover, carrying out the heating drive before, during and after the flushing process allows the heating of the discharge liquid L to be accomplished without sacrificing the operating efficiency of the droplet discharging apparatus.

The droplet discharging apparatus can be used for extensive applications, including the following applications:

(1) A printing apparatus for drawing characters and pictures by discharging ink as the discharge liquid L toward paper or various types of film as the object W.

(2) A pattern drawing apparatus for drawing wiring patterns for electronic circuits by discharging an electrically conductive liquid as the discharge liquid L toward a substrate as the object W.

(3) A microlens manufacturing apparatus for producing microlenses by discharging a transparent resin as the discharge liquid L onto a substrate as the object W. In this case, the transparent resin adhering to the substrate is solidified by applying ultraviolet rays or the like to eventually form a microlens on the substrate.

(4) A color filter manufacturing apparatus for forming color layers for color filters by discharging a coloring resin as the discharge liquid L onto a substrate as the object W.

(5) An organic EL display panel manufacturing apparatus for forming organic electroluminescence (EL) display panels by discharging an electro-optical material, namely, a fluorescent organic chemical compound exhibiting electroluminescence, as the discharge liquid L to a substrate as the object W.

In the embodiment described above, the heating drive period Th is set before, during and after the flushing process to carry out the heating drive on the piezoelectric elements 30 before, during and after the flushing process. Alternatively, however, a relatively short heating drive period Th may be set in the normal drive period Tn so as to restrain a temperature drop of the discharge liquid L. The repetitive frequency (100 kHz) of the heating drive signal HD in the embodiment is set to ten times the repetitive frequency (10 kHz) of the normal drive signal ND. In other words, the heating drive signal HD is set to be a signal of a considerably shorter cycle than the normal drive signal ND. This makes it possible to easily insert the heating drive signal HD of a few cycles (i.e., for a short period) between the normal drive signals ND.

As explained in detail above, according to the present invention, the apparatus is adapted to discharge a discharge liquid in the form of droplets from apertures by mechanically deforming the piezoelectric elements by the normal drive signal. The heating drive signal of a repetitive frequency in an ultrasonic band is applied to the piezoelectric elements without discharging droplets from the apertures. In other words, the piezoelectric elements are driven at the repetitive frequency in the ultrasonic band without discharging droplets, so that the temperature of the discharge liquid can be rapidly heated and maintained or set to a predetermined temperature or higher. This makes it possible to effectively prevent discharging failure attributable to a temperature drop of the discharge liquid.

This application claims priority to and hereby incorporates by reference Japanese patent application No. 2002-319678 filed Nov. 1, 2002.

What is claimed is:

1. A droplet discharging apparatus comprising:
means for discharging a discharge liquid in the form of droplets through an aperture by mechanically deforming a piezoelectric element by a normal drive signal, and
wherein the piezoelectric element is subjected to a heating drive signal of a repetitive frequency in an ultrasonic band, the heating drive signal being insufficient to cause droplets from being discharged through the aperture thereby facilitating heating of the droplets.

2. The droplet discharging apparatus according to claim 1, wherein the heating drive signal is applied to the piezoelectric element immediately before a droplet is discharged by the normal drive signal.

3. The droplet discharging apparatus according to claim 1, wherein the heating drive signal is applied to the piezoelectric element while a droplet is being discharged by the normal drive signal.

4. The droplet discharging apparatus according to claim 1, wherein the heating drive signal is applied to the piezoelectric element if the temperature of a discharge liquid that is detected by a temperature detecting means drops below a predetermined threshold temperature.

5. The droplet discharging apparatus according to claim 1, wherein the repetitive frequency of the heating drive signal is 40 kHz or more.

6. The droplet discharging apparatus according to claim 1, wherein the amplitude of the heating drive signal is half that or less of the normal drive signal.

7. The droplet discharging apparatus according claim 1, wherein the discharge liquid is a printing ink.

8. The droplet discharging apparatus according to claim 1, wherein the discharge liquid is an electrically conductive material for forming a wiring pattern.

9. The droplet discharging apparatus according claim 1, wherein the discharge liquid is a transparent resin for forming a microlens.

10. The droplet discharging apparatus according to claim 1, wherein the discharge liquid is a resin for forming a color layer of a color filter.

11. The droplet discharging apparatus according to claim 1, wherein the discharge liquid is an electro-optic material.

12. The droplet discharging apparatus according to claim 11, wherein the electro-optic material is a fluorescent organic compound presenting electroluminescence.

13. The droplet discharging apparatus according to claim 12, wherein the heating drive signal is applied to the piezoelectric element before, during and after preliminary discharging (flushing).

14. A droplet discharging method comprising:
discharging a discharge liquid in the form of droplets through an aperture by mechanically deforming a piezoelectric element by a normal drive signal, and
wherein the discharge liquid is heated by subjecting the piezoelectric element to heating drive signal at a repetitive frequency in an ultrasonic band, the heating drive signal being insufficient to cause the discharge liquid from being discharged through the aperture thereby facilitating heating of the droplets.

15. The droplet discharging method according to claim 14, wherein the heating drive is carried out immediately before the normal drive for discharging a droplet.

16. The droplet discharging method according to claim 14, wherein the heating drive is carried out during the normal drive.

17. The droplet discharging method according to claim 14, wherein the heating drive is carried out if the temperature of a discharge liquid drops below a predetermined threshold temperature.

18. The droplet discharging method according to claim 14, wherein the repetitive frequency of the heating drive is 40 kHz or more.

19. The droplet discharging method according to claim 14, wherein the heating drive is carried out at an amplitude that is half that or less of the normal drive.

20. The droplet discharging method according to claim 14, wherein the discharge liquid is a printing ink.

21. The droplet discharging method according to claim 14, wherein the discharge liquid is an electrically conductive material for forming a wiring pattern.

22. The droplet discharging method according to claim 14, wherein the discharge liquid is a transparent resin for forming a microlens.

23. The droplet discharging method according to claim 14, wherein the discharge liquid is a resin for forming a color layer of a color filter.

24. The droplet discharging method according to claim 14, wherein the discharge liquid is an electro-optic material.

25. The droplet discharging method according to claim 24, wherein the electro-optic material is a fluorescent organic compound presenting electroluminescence.

26. The droplet discharging method according to claim 14, wherein the heating drive signal is applied to the piezoelectric element before, during and after preliminary discharging (flushing).
